(19) United States
(12) Patent Application Publication
(10) Pub. No.: US 2023/0368591 A1
(43) Pub. Date: Nov. 16, 2023

(54) METHOD FOR MONITORING FAILURE OF MOTOR IN A CAR BASED ON CLUSTERING ALGORITHM AND SYSTEM USING THE SAME

(71) Applicants: SKAIChips Co., Ltd., Suwon-si (KR); Research & Business Foundation SUNGKYUNKWAN UNIVERSITY, Suwon-si (KR)

(72) Inventors: Kang Yoon LEE, Seoul (KR); Dong Gyun KIM, Suwonsi (KR); Dae Young CHOI, Suwon-si (KR); Jong Wan JO, Suwon-si (KR); Young Gun PU, Suwon-si (KR)

(73) Assignees: SKAIChips Co., Ltd., Suwon-si (KR); Research & Business Foundation SUNGKYUNKWAN UNIVERSITY, Suwon-si (KR)

(21) Appl. No.: 18/195,902

(22) Filed: May 10, 2023

(30) Foreign Application Priority Data
May 10, 2022 (KR) 10-2022-0057462

(51) Int. Cl. G07C 5/08

(52) U.S. Cl. CPC G07C 5/0816

(57) ABSTRACT

According to various embodiment of the present invention, in a diagnosis system including a sensing module that senses the state of a motor is installed in a car, disclosed are a method for determining failure of a motor in a car comprising the steps of: (a) acquiring sensed values by sensing the state variables of the motor by the sensing module; (b) extracting two or more feature values by converting the sensed values acquired by the sensing module; (c) generating two clusters which classify and include the two or more feature values based on the two or more feature values and determining a normal cluster among the two clusters; and (d) determining the state of the motor as a failure-expected state or a safe state by applying at least one classifier to the feature values included in the normal cluster.

### CROSS-REFERENCE TO RELATED APPLICATION(S)

This application claims priority from Korean Patent Application No. 10-2022-0057462, filed on May 10, 2022, in the Korean Intellectual Property Office, the disclosure of which is incorporated herein by reference in its entirety.

### BACKGROUND

### 1. Field

The present invention relates to a method for monitoring failure of a motor in a car based on a clustering algorithm and a system using the same, more specifically, relates a method for clustering feature values extracted by converting sensed values of a motor in a car sensed by a sensing module while a diagnosis system including the sensing module which senses the state of the motor in the car is installed inside the car and determining failure of the motor by using some of the clusters and a system using the same.

### 2. Description of Related Art

PHM (Prognostic and health management) is a technology to diagnose the state of a driving system and predict failure of the same. Although PHM has already been applied to automobiles, it was only used for an analysis by transferring data to an external cloud server, etc. through a network at a failure diagnosis center, etc., but it has never been implemented on a single chip inside a car.

In other words, rather than diagnosing the state of the car's driving system on the system inside the car (SoC), the state of the car is diagnosed through an external server. Accordingly, there is a problem in that it must be interlocked with an external server through a network, and it may be difficult to diagnose in real time.

In order to solve the above problem, the inventor proposes a method for determining failure of a motor in a car and a system using the same.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

The present invention may have the following objects.

The present invention is to provide a method and system for diagnosing the state and failure of a motor in a car through a diagnosis system installed inside the car.

In addition, the present invention is to provide a method and system for monitoring the state of a driving system in a car in real time using AI technology.

In addition, the present invention is to provide a method and system for predicting information related to lifetime as well when predicting failure of a driving system in a car.

However, the problem to be solved by the present invention is not limited to the above-mentioned problem, and other problems that are not mentioned will be clearly understood by those skilled in the art from the following description.

According to an embodiment of the present invention, a method for monitoring failure of a motor in a car based on a clustering algorithm when a system for monitoring failure of the motor is mounted in the car and includes a sensing module sensing the state of the motor, the method comprising: (a) acquiring sensed values by sensing the state variables of the motor by the sensing module; (b) extracting two or more feature values by converting the sensed values acquired by the sensing module; (c) generating two or more clusters which classify and include the two or more feature values based on the two or more feature values and determining a normal cluster among the two or more clusters; and (d) determining the state of the motor as a failure-expected state or a safe state by applying at least one classifier to the feature values included in the normal cluster.

According to a more illustrative embodiment, in the step (b) the two or more feature values are extracted based on a result of applying the sensed values to an equation having converted values of sensed temperatures, converted values of sensed voltages, and/or converted values of sensed currents as variables.

According to a more illustrative embodiment, in the step (c) the two or more clusters are generated based on a result of applying the feature values to a k-means clustering algorithm.

According to a more illustrative embodiment, in the step (d) the state of the motor is determined based on the classifier including at least some of a linear classification algorithm and/or a Gaussian classification algorithm.

According to a more illustrative embodiment, applying the sensed values to the equation is processed by at least one Artificial Intelligence (AI) module.

According to a more illustrative embodiment, applying the feature values to a clustering algorithm is processed by at least one AI module.

According to a more illustrative embodiment, at least some of the classification algorithms are processed by at least one AI module.

According to a more illustrative embodiment, at least one feature value included in the normal cluster comprises information indicating a normal state or an abnormal state of the motor by comparison with at least one reference value preset.

According to a more illustrative embodiment, the step (c) comprises: comparing the feature values located in domains designated as center points of each of the two clusters, or comparing mean values of the feature values when there are a plurality of the feature values located in the domains designated as the center points of each of the two clusters; and determining, through the comparison, a cluster including a feature value relatively closer to a normal state based on the set reference value as a normal cluster.

According to a more illustrative embodiment, the step (d) comprises: determining, when the state of the motor is determined as the failure-expected state, a failure-expected period in which failure of the motor is expected based on the information indicating the failure-expected state of the motor, wherein the information is included in at least some of the feature values of the normal cluster.

According to another embodiment of the present invention, a system for monitoring failure of a motor in a car based on a clustering algorithm, comprising: a sensing module for sensing a state variables of the motor in the car and acquiring sensed values; a motor state determination module for extracting two or more feature values by converting the sensed values acquired by the sensing module, and for generating two or more clusters that classify and include the two or more feature values based on the two or more feature values, and for determining a normal cluster among the two or more clusters, and for determining a state of the motor as a failure-expected state or a safe state by applying at least one classifier to the feature values included in the normal cluster, wherein the system is mounted in the car.

Other features and aspects will be apparent from the following detailed description, the drawings, and the claims.

### BRIEF DESCRIPTION OF THE DRAWINGS

FIG. 1 is a diagram illustrating a schematic configuration of a diagnosis system according to an embodiment of the present invention.

FIG. 2 is a diagram illustrating a specific configuration of a diagnosis system according to an embodiment of the present invention.

FIG. 3 is a diagram illustrating a process of predicting a failure of a motor or determining safety thereof according to an embodiment of the present invention.

FIG. 4 is a diagram illustrating that feature values extracted according to an embodiment of the present invention are classified into two clusters.

FIG. 5 is a diagram illustrating a learning process of an AI module according to an embodiment of the present invention.

FIG. 6 is a diagram illustrating a process of extracting feature values according to an embodiment of the present invention.

Throughout the accompanying drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description of the present invention refers to the accompanying drawings that show, as examples, specific embodiments in which the present invention may be implemented. These embodiments are described in sufficient detail to enable those of ordinary skill in the art to implement the present invention. It should be understood that various embodiments of the present invention are different but are not mutually exclusive. For example, certain shapes, structures, and characteristics described herein may be implemented in other embodiments without departing from the spirit and scope of the present invention in connection with an embodiment. It should also be understood that the positions or arrangement of individual elements in each disclosed embodiment may be varied without departing from the spirit and scope of the present invention. Therefore, the following detailed description is not to be taken in a limiting sense, and the scope of the present invention is limited only by the appended claims along with the full scope of equivalents to which the claims are entitled when properly explained. In the drawings, like reference numerals refer to the same or similar functions throughout several aspects.

Hereinafter, exemplary embodiment of the present invention will be described in detail with reference to the accompanying drawings so that those of ordinary skill in the art can easily implement the present invention.

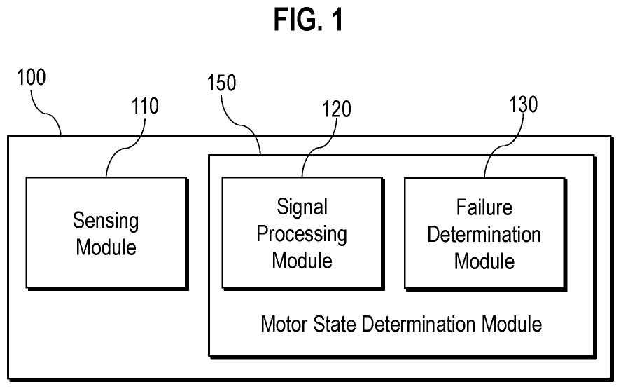

FIG. 1 is a diagram illustrating a schematic configuration of a diagnosis system according to an embodiment of the present invention.

As shown in FIG. 1, the diagnosis system 100 of the present invention may comprise a sensing module 110 and a motor state determination module 150. The motor state determination module 150 may comprise a signal processing module 120 and a failure determination module 130. The diagnosis system 100 can be installed inside a car and can perform several functions in the form of a System on Chip (SoC). That is, as a kind of semiconductor, the diagnosis system is able to play a role in diagnosing devices inside the car.

Specifically, the diagnosis system 100 of the present invention diagnoses the state of a driving system of a car, and in particular, is able to perform state diagnosis of electric motors, actuators, and the like.

In addition, although not shown in the figures, the diagnosis system 100 is able to include a communication unit, a processor, a storage unit, and the like.

The communication unit 120 may be implemented by various communication technologies. Namely, WIFI, WCDMA (Wideband CDMA), HSDPA (High Speed Downlink Packet Access), HSUPA (High Speed Uplink Packet Access), HSPA (High Speed Packet Access), Mobile WiMAX, WiBro, LTE (Long Term Evolution), 5G, 6G, bluetooth, IrDA (Infrared Data Association), NFC (Near Field Communication), Zigbee, a wireless LAN technology and the like may be applied. In addition, when connecting to the Internet to provide services, TCP/IP, which is a standard protocol for information transmission on the Internet, can be followed.

The storage unit may include at least one database to diagnose the state of the driving system of the car. For example, the storage unit may include artificial intelligence algorithms including at least some of artificial neural network algorithms, blockchain algorithms, deep learning algorithms, and mechanisms, operators, language models, and big data related thereto for the processing of operations performed by the diagnosis system 100, such as data sensing, failure factor extraction, cluster generation, linear classification, and/or Gaussian classification.

In addition, the storage unit may store a database including information related to the driving system of the car and at least some components thereof.

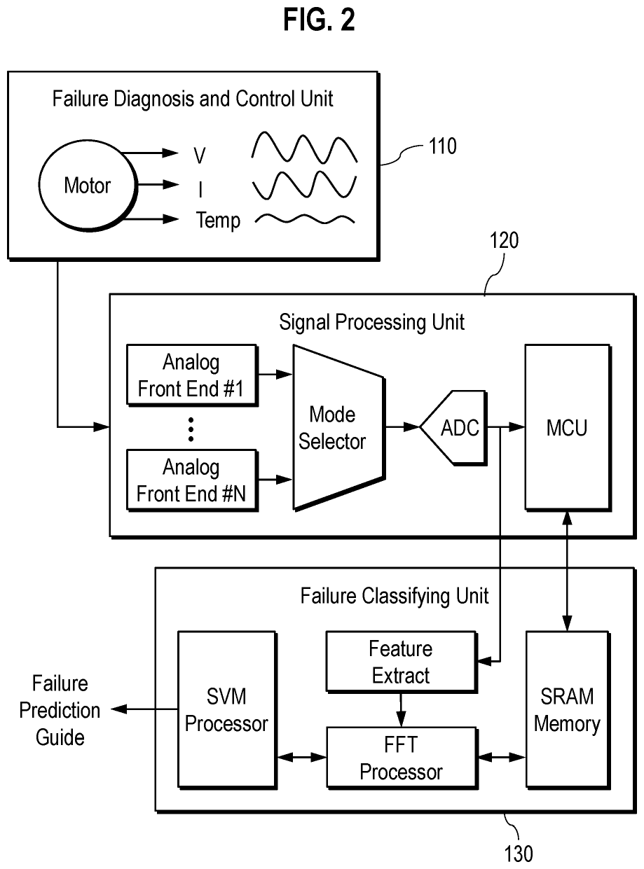

FIG. 2 is a diagram illustrating a specific configuration of a diagnosis system according to an embodiment of the present invention.

For reference, FIG. 2 is a diagram illustrating the diagnosis system (FIG. 1) of the present invention in more detail. According to one embodiment, a sensing module 110 corresponds to a failure diagnosis and control unit, and a signal processing module 120 corresponds to the signal processing unit, and a failure determination module 130 may correspond to a failure classifying unit.

Hereinafter, the process performed by the diagnosis system of the present invention will be described, focusing on the sensing module 110, the signal processing module 120, and the failure determination module 130.

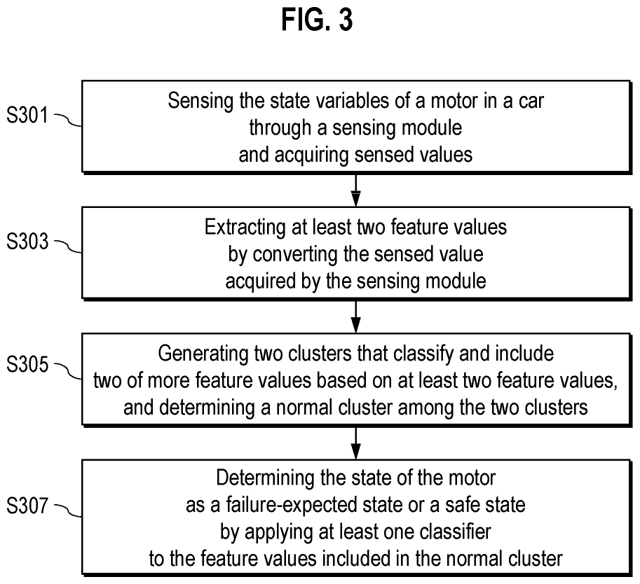

FIG. 3 is a diagram illustrating a process of predicting a failure of a motor or determining safety thereof according to an embodiment of the present invention.

First of all, it can be assumed that a diagnosis system 100 including a sensing module 110 for sensing the state of a motor in a car is installed in the car.

In the step S301, the diagnosis system 100 is able to sense the state of at least one motor in the car through the sensing module 110 and acquire sensed values. Herein, the sensing module 110 is able to measure state variables of motor, for example a temperature (Temp), a voltage (V), and/or a current (I) of the motor by using various sensors, and the measured values for state variables are the sensed values. For example, the acquired temperature, voltage, and/or current of the motor are analog values, as shown in FIG. 2

In the step S303, the diagnosis system 100 is able to extract a feature value by converting the sensed value acquired by the sensing module 110. The sensed values may be transmitted to the signal processing module 120 and the failure determination module 130 and converted into the feature value. Here, the signal processing module 120 may include a plurality of Analog Front End (AFEs), a Mode Selector, an Analog Digital Converter (ADC), an Micro Controller Unit (MCU), and the like.

Specifically, the sensed values (temperature, voltage, and/or current in analog form) acquired through the sensing module 110 may be transmitted to the ADC through several AFEs and converted into digital form. Here, each of the sensed values of temperature, voltage, and/or current, which is the measured values by sensing module 110, is transmitted through different AFEs and each of those may pass through an Amp, a Filter, and the like.

In addition, the sensed values (temperature, voltage, current) digitally converted may be transmitted to the failure determination module 130, passed through a Fast Fourier Transform (FFT) Processor and the like, and then extracted as the feature value by an Artificial Intelligence (AI) module (not shown) after passing through an FFT processor or the like. That is, the feature value may be determined by the AI module or the like based on the sensed values of motor, such as temperature, voltage, and/or current.

Herein, the AI module may be included in the failure determination module 130, and may exist on a chip of the diagnosis system 100 as a separate module depending on the case. The feature value may be extracted by referring to the calculation formula as follows.

Feature Value=Ax+By+Cz+D

Here, A, B, C, D are variables (parameters), x is the converted value of the sensed temperature value, y is the converted value of the sensed voltage value, z is the converted value of the sensed current value. The converted values may be obtained by applying a Fourier transform to the sensed values. By setting some variables to 0, the feature value may be extracted from selected converted values.

The AI module may refer to the above formula. When temperature, voltage, current, and the like are measured by time period, the feature values may also be extracted by time period and form as a two-dimensional graph (x-axis: time, y-axis: feature value). The formula described above may vary depending on the setting.

That is, the feature value extracted from the sensed values may indicate the state of the corresponding motor by dividing it into several stages. Namely, when expressing the state of the motor as a normal state or an abnormal state, the feature value contains information capable of classifying each state of the motor into a plurality of stages. It is possible to determine a failure-expected period until failure of the motor is expected and/or a time point of failure of motor by using such information.

In addition, according to various embodiments of the present invention, the abnormal state does not necessarily mean that the device is damaged, and may mean a state outside the range of a normal state or a state in which an abnormality has occurred, requiring inspection.

In the step S305, the diagnosis system 100 is able to generate a specified number (e.g., two) of clusters or cluster groups that classify and include two or more feature values based on the extracted two or more feature values, and determine a normal cluster or a group of normal clusters among the two or more clusters or cluster groups. However, when the diagnosis system 100 classifies the extracted feature values into a plurality of clusters, feature values may be classified into three or more clusters depending on predetermined setting information.

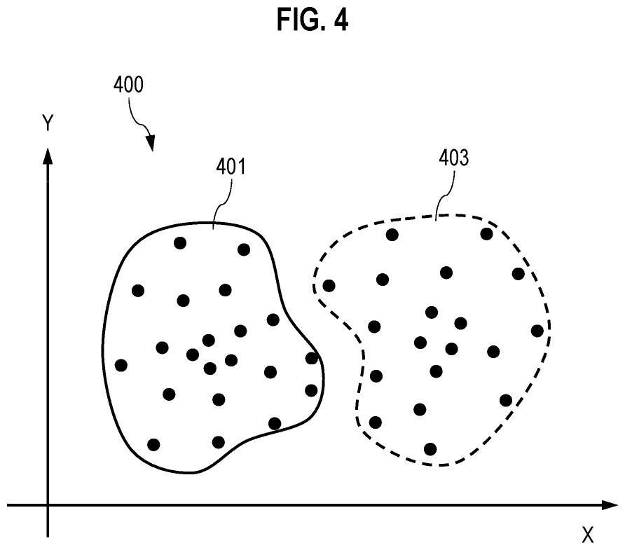

According to an embodiment of the present invention, FIG. 4 is a diagram illustrating that the feature values extracted by a diagnosis system 100 according to an embodiment of the present invention are classified into two clusters.

Referring to FIG. 4, the x-axis and y-axis of a graph 400 may be configured to represent conditions of a car forming the feature value of a designated motor, for example, each component or combination of components of temperature (Temp), voltage (V), and/or current (I) of a motor specified by using a sensor, or features modified by a designated formula. On the other hand, although not shown in the figure, the x-axis may represent time (t) and the y-axis may represent feature values.

The diagnosis system 100 is able to determine the number of center points (and/or center point domains, hereinafter, center points) of feature values extracted based on the set number of clusters. For example, when the diagnosis system 100 is set to classify feature points into two clusters, the diagnosis system is able to determine two central feature values based on the variance of the feature values.

The diagnosis system 100 is able to form two clusters by including the same or similar feature values in the same cluster based on each of the determined central feature values, in the same cluster. At this time, when determining a cluster to include feature values located in a boundary domain of two clusters, the diagnosis system 100 is able to determine the cluster including the feature values based on a database of other cars, for example, the data of a correct-answer car with ground truth used for learning of the AI module.

Without being limited to the method described above, the diagnosis system 100 is able to classify extracted feature values into two clusters using at least one clustering algorithm.

For example, the diagnosis system 100 is able to classify and include the feature values into two clusters 401, 403 by applying at least some algorithms among partitioning clustering algorithms and hierarchical clustering algorithms, preferably, by applying a k-value (number of clusters, e.g.: 2) set in a k-means clustering algorithm, which is one of the partitioning clustering algorithms.

The diagnosis system 100 is able to determine at least one cluster between the two generated clusters as a normal cluster.

According to an embodiment, a diagnosis system 100 is able to determine a normal cluster 403 among clusters based on a clustering algorithm applied to extract feature values and/or information set to extract feature values.

In order to determine a cluster as a normal cluster or an abnormal cluster, the diagnosis system 100 needs to check information related to a state of a motor indicated by each feature value included in each cluster.

For example, the diagnosis system 100 is able to determine the state of a motor indicated by a feature value as at least one of a normal state and an abnormal state based on a reference value stored in setting information. At this time, the state of the motor determined based on the feature value may be a preliminary determination for determining the cluster as a normal cluster or an abnormal cluster.

Here, the reference value may be set in advance as a criterion for comparing the size with the extracted feature value. For a car in which a (normal or abnormal) state of a mounted motor has been determined in advance, a feature value of the motor of the car can be checked in advance (by using the formula: Feature Value=Ax+By+Cz+D), and a reference value can be set based on the feature value.

For example, based on the database, if a motor of a Vehicle A (measured temperature: t+1) is in an abnormal state and the motor of a Vehicle B (measured temperature: t) is in a normal state, the reference value can be preset to a value between the feature value of the Vehicle B (the measured temperature t is applied to the formula) and the feature value of the Vehicle A (the measured temperature t+1 is applied to the formula).

As above, in case the reference value is preset to 10, the diagnosis system 100 is able to determine that the motor of the car is in an abnormal (or failure) state when the extracted feature value of the car is greater than 10 and the motor of the car is in a normal state when the extracted feature value of the car is less than or equal to 10. On the other hand, depending on the setting, the diagnosis system is able to determine that the motor of the car is in an abnormal state when the feature value is less than the reference value.

In addition, it can be assumed that customized reference values can be classified into a plurality of classes based on the conditions of a car. The plurality of classes may include a first class, a second class, and the like.

Here, the conditions of a car may include a car manufacture year, an ambient temperature of a car, and the like. For example, cars older than 5 years may correspond to the first class while and cars less than 5 years may correspond to the second class, or cars at an ambient temperature of 20 degrees or higher may correspond to the first class while cars at an ambient temperature less than 20 degrees may correspond to the second class.

Of course, the plurality of classes is not limited to the first and second classes, and other additional classes (e.g., third class, fourth class, and the like) may exist. In addition, the conditions of a car may also include factors other than a car manufacture year and an ambient temperature thereof.

In addition, it can be assumed that a customized reference value is set for each class. Here, the customized reference value is an object to be compared with an extracted feature value, and can be a criterion to determine whether a motor and the like (driving system) is in a normal state or an abnormal state.

Specifically, it can be assumed that the reference value corresponding to the first class is set as a first reference value, and the reference value corresponding to the second class is set as a second reference value. In this case, when a car corresponds to the first class, the diagnosis system 100 is able to determine whether the motor is in a normal state or an abnormal state based on the feature value and the first reference value.

For example, it may be determined whether the motor of the car is in an abnormal state in case the feature value is greater than the first reference value or in a normal state in case the feature value is smaller than the first reference value.

In addition, when a car corresponds to the second class, the diagnosis system is able to determine whether the motor is in a normal state or an abnormal state based on the feature value and the second reference value. For example, it may be determined that the motor of the car is in an abnormal state in case the feature value is greater than the second reference value and in a normal state in case the feature value is smaller than the second reference value.

In case that a car manufacture year is included in the conditions of a car and the car corresponding to the first class is manufactured earlier than the car corresponding to the second class, the first reference value may be greater than the second reference value. That is, the reference value of an older car is smaller than the reference value of a car manufactured earlier.

In the case of a car with an older model year, even if it is not in an abnormal state, it may be in a state in which at least of one among temperature, voltage, and current increases even in normal times, so it is necessary to determine more flexibly the motor in a normal state or an abnormal state.

For example, since the first reference value (b) of the first class is greater than the second reference value (a) of the second class, the abnormal occurrence range may also be different by class. A car corresponding to the first class may be in an abnormal state if the feature value is greater than b, and a car corresponding to the second class may be in an abnormal state if the feature value is greater than a.

As a result, the range corresponding to the abnormal state may be determined to be wider as the car is manufactured earlier or located in a lower temperature area, wherein the car corresponds to the second class.

As described above, each of the extracted feature values includes information enabling the determination on the state of the corresponding motor, for example, a normal state or an abnormal state, and the diagnosis system 100 is able to determine the state of the motor indicated by the feature value using the set reference value.

The diagnosis system 100 is able to check the state of the motor determined based on each feature value included in each of the two or more generated clusters, and determine a cluster including more feature values indicating that the motor is in a normal state as a normal cluster.

Here, the state of a cluster is to determine the state of the cluster including feature values based on feature value preliminarily determined. The feature values may indicate the state of the motor, but in the present invention, the grade of the cluster may be defined as a process for more accurately judging and determining the state of the motor.

According to one embodiment, the diagnosis system 100 is able to classify two or more clusters into a normal cluster and an abnormal cluster. In this case, the normal clusters may be determined based on feature values included in each cluster.

For example, the diagnosis system 100 is able to determine a normal cluster among two clusters based on conditions preset in setting information such as: i) a cluster including the largest feature value; ii) a cluster with relatively large mean value of feature values; iii) a cluster including more feature value indicating that the motor is in a normal state; iv) a cluster including less feature value indicating that the motor is in an abnormal state; and v) a cluster including a feature value closer to a normal state by comparing feature values in domains designated as center points of each of the two clusters.

That is, the diagnosis system 100 is able to determine the state of the motor based on the feature value by applying the reference value set in the step S305. However, the diagnosis system 100 according to the present invention may perform the step S307 using a normal cluster in order to further improve accuracy in determining the state of the motor.

In addition, although not described through FIG. 3, the diagnosis system 100 further includes a failure determination process for determining the state of the motor as a failure state based on the state of the motor indicated by the feature values included in each of the two clusters.

For example, the diagnosis system 100 is able to, when assuming that a feature value greater than the third reference value (e.g. 10) among feature values included in both clusters is a result of preliminary determination indicating an abnormal state of the motor, determine the state of the motor as a failure state when the ratio of feature values greater than the third reference value is greater than the fourth reference value (e.g. 90%). Here, the third reference value and/or the fourth reference value may be changed.

As another example, the diagnosis system 100 is able to determine the state of the motor as a failure state when the mean value of feature values included in the abnormal cluster is greater than the fifth reference value. The diagnosis system 100 is able to, when determining that a motor is in a failure state through the failure determination process, terminate the operation shown in FIG. 3 and then output a notification message about the failure of the corresponding motor.

Although the state of the motor is not a failure state, a feature value may be determined as a value indicating an abnormal state due to the environment during measurement and malfunction of the sensor. As a result, the feature values belonging to the abnormal cluster increase. For example, when the number of feature values belonging to the abnormal cluster is greater than the reference value, or the central value of the abnormal cluster is greater than the reference value, the state variables of the motor such as temperature, voltage, and/or current, may be measured again or additionally. Then, feature values may be extracted from the sensed values, and the feature values may be clustered again.

According to various embodiments, a diagnosis system 100 is able to confirm that both of two generated clusters are normal clusters. According to an embodiment, when a mean value of feature values included in each of two clusters is greater than a sixth reference value (e.g. 90%), a diagnosis system 100 is able to determine the state of a motor as a safe state.

The diagnosis system 100 is able to, when determining that the state of the motor is in a safe state, terminate the operation of FIG. 3.

In the step S307, the diagnosis system 100 is able to determine the state of the motor as a failure-expected state or a safe state by applying the feature values included in a group of the normal clusters 403 to at least one classification algorithm.

The diagnosis system 100 is able to determine the state of the motor by applying at least one classification algorithm to the feature values included in the clusters 403 in a normal state. At this time, at least one classification algorithm may be processed by an AI module or a separately configured classifier (not shown). The classifier may receive a plurality of feature values and output a state of motor.

Here, the classification algorithm may include at least some of a linear classification algorithms and a Gaussian classification algorithm.

The diagnosis system 100 is able to determine whether a designated motor in the normal clusters 403 is in a safe state or a failure-expected state through a classification algorithm.

In addition, in determining the state of the motor in the car, the diagnosis system 100 is able to, when determining the motor is in the failure-expected state, further determine a failure-expected period until failure of the motor is expected based on the state of motor indicated by feature values included in the normal clusters 403. For example, the diagnosis system 100 is able to determine a failure-expected period of motor failure in days, weeks, months, and/or years based on the setting information and feature values included in the normal clusters 403.

For example, the diagnosis system 100 can check predetermined data related to the time of failure of the corresponding motor of the same or similar car as the corresponding car and the period required until the failure state based on the database of a correct-answer car.

The diagnosis system 100 is able to determine a failure-expected period until the failure of the corresponding motor occurs by comparing data of manufacture years, total mileage, and/or feature values of a car with those of a correct-answer car. At this time, the data of the correct-answer car may be data of a plurality of correct-answer cars.

The diagnosis system 100 is able to, when determining the failure-expected period based on the feature values included in the normal cluster, calculate the failure-expected period based on the feature values in a domain designated as a center point of the cluster in a normal state.

In addition, the diagnosis system 100 is able to, when determining the failure-expected period in which motor failure is expected, determine the failure-expected period by additionally considering feature values included in the abnormal cluster.

For example, the diagnosis system 100 is able to shorten or extend the failure-expected period determined based on the number (or ratio) of feature values included in an abnormal cluster and at least some of the feature values included in a domain designated as a center point.

In addition, when the failure-expected state of the motor is determined, the diagnosis system 100 is able to determine when to inspect (e.g., repair or replace) the motor based on the failure-expected period.

At this time, the diagnosis system 100 is able to determine the time of inspection of the motor in days, weeks, months, and/or years based on the class of a car, a role of a motor and feature values included in the abnormal clusters and/or shorten or extend a failure-expected period in which a failure of the motor is expected, and determine that an urgent inspection is required when confirming that the inspection time is within a designated period.

According to one embodiment, for a motor set to require an urgent inspection when a car corresponds to a first class, a motor is related to the operation of the car, and a failure-expected period where the failure of the motor is expected is within one week, a diagnosis system 100 is able to determine that a motor requires urgent inspection when the car corresponds to a first class, there is no history of repair or replacement of a motor, the motor related to regenerative breaking is in a failure-expected state, and a failure-expected period wherein the failure of the motor is expected based on feature values included in an abnormal cluster is for three days.

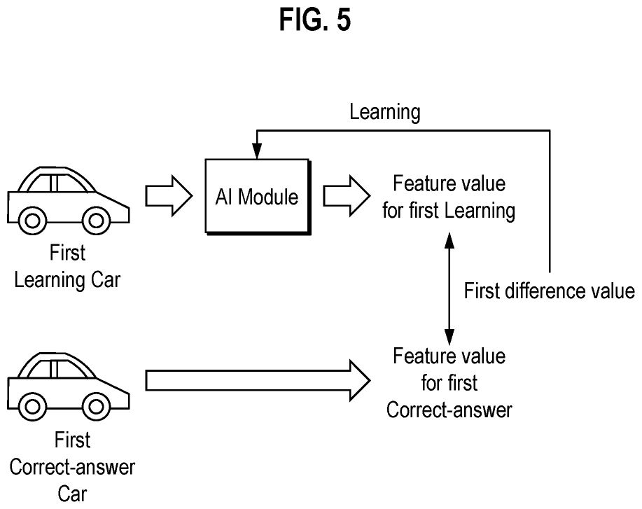

In addition, in performing learning of the AI module related to classification algorithms, the diagnosis system 100 is able to perform the learning of the classification algorithm in the same or similar way as the learning of the AI module shown in FIG. 5, thereby improving the determination accuracy of the AI module.

FIG. 5 is a diagram illustrating a learning process of an AI module according to an embodiment of the present invention. Hereafter, I will explain the learning process of the AI module for extracting feature values from sensed values with FIG. 5.

First, for learning of the AI module, it can be assumed that a plurality of cars for learning is classified into classes (e.g. first class, second class, etc.) matched based on each condition (e.g. manufacture year, ambient temperature).

Next, the diagnosis system 100 is able to extract feature values for first learning from the plurality of first learning cars included in the first class by using the AI module. In addition, the diagnosis system 100 is able to acquire feature values for a first correct answer from the correct-answer car included in the first class.

Here, the feature value for the first correct answer may correspond to a value representing the actual state of the correct-answer car (abnormal state or normal state confirmed based on a temperature, a voltage, and/or a current). In the case of a car for an actual correct answer, it corresponds to a car for which a malfunction has already been recognized, and accordingly, the feature value for the first correct answer may also be specified as a value greater than the reference value (for example, if the reference value is preset to be 10, the feature value for the first correct answer is specified as one of 10 or greater numbers).

In addition, the diagnosis system 100 is able to acquire a first difference value by comparing the feature value for the first correct answer and the feature value for the first learning, and then update parameters of the AI module based on the first difference value. That is, the diagnosis system 100 is able to perform a process of checking the difference between the feature value for the first correct answer and the feature value for the first learning, and updating the parameters of the AI module so that there is no such difference (so that the feature value for the first learning matches the feature value for the first correct answer).

The process of updating the parameters of the AI module as described above may be repeatedly performed, and as the number of performing the process increases, more accurate determination (extraction of feature values) of the AI module may be possible.

Also, as in the first class, the diagnosis system 100 is able to extract feature values for second learning from a plurality of second learning-cars included in the second class by using the AI module.

In addition, the diagnosis system 100 is able to acquire a feature value for a second correct answer from the second learning-cars included in a second class, and compare it with the feature value for the second learning to acquire a second difference value. In addition, the diagnosis system is able to perform a process of updating parameters of the AI module based on the second difference value.

As described above, the diagnosis system is able to repeatedly update the parameters of the AI module by using the learning-cars and the correct-answer cars included in the first class and the second class, respectively, thus performing the learning of the AI module through this.

Although it has been described above that the diagnosis system 100 determines whether the motor is in the abnormal state based on the feature value, in some cases, the diagnosis system is able to further subdivide and determine the state of motor, such as whether the motor is in a failure state, whether the motor is in a failure-expected state in which failure is expected within a predetermined period (for example, 1 year), and whether the motor is in a safe state based on the feature value. The predetermined period may be preset and may be changed according to conditions.

Specifically, two or more reference values (for example, p, q) may be preset, and normal (safe) state, failure-expected state, or failure state may be determined based on the reference value and the extracted feature value.

The diagnosis system 100 is able to determine that the installed motor is in a normal state when the extracted feature value is equal to or smaller than the reference value p, the installed motor is in a failure-expected state when the extracted feature value is greater than the reference value p and less than or equal to the reference value q, and the installed motor is in a failure state when the extracted feature value is greater than the reference value q.

Here, the diagnosis system 100 is able to set the reference value as above using an AI module that completed the learning (it may be different from the AI module that extracts feature values). In other words, the diagnosis system is able to repeatedly perform the learning process of extracting reference values by processing data acquired from measured values such as temperature, current, and voltage of a car (in a failure state, in a normal state), and then passing them through the AI module. Of course, the reference value may be arbitrarily set without passing through the AI module that completed the learning or the like.

On the other hand, by presetting at least three reference values in the case of frequently used cars and cars (for example, taxi, kindergarten bus, etc.) in which safety issues should be considered more strictly, three or more reference values are set in advance, the diagnosis system is able to determine the state of the installed motor as a normal state, a state in which failure is expected within 6 months, a state in which failure is expected within 3 years, and a failure state. That is, the diagnosis system is able to determine a predetermined period (e.g., 6 months, 3 years, etc.) in more detail, such as day, week, month, etc.

The diagnosis system 100 may generate a guide message including the state of the motor confirmed as described above and/or an expected period of failure of the motor, and store it in the car's storage, or output it through a display and/or a speaker.

In addition, in performing a learning process of an AI module, the diagnosis system 100 is able to learn information on feature values that exist in a designated domain on the boundary of two clusters 401, 403 after performing a clustering operation. The diagnosis system 100 is able to perform the same or similar process as the embodiment shown in FIG. 5 for the sensed values of the motors included in the car, the feature values extracted based on the sensed values, and the feature values classified into the two clusters, thereby improving the determination accuracy of the AI module.

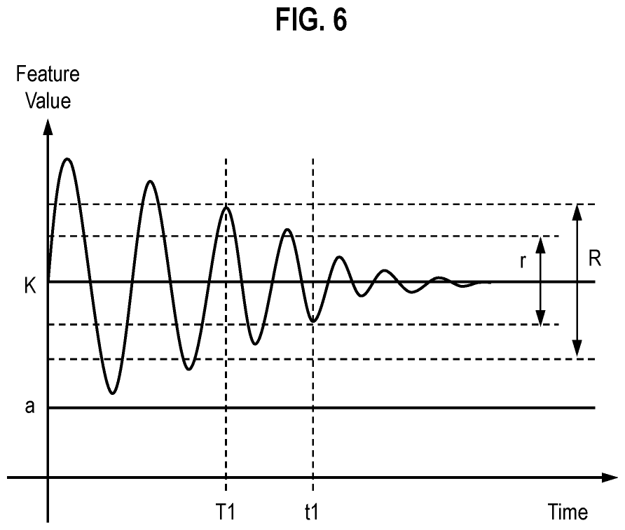

FIG. 6 is a diagram illustrating a process of extracting feature values according to an embodiment of the present invention.

As described above, the feature value extracted through the AI module or the like are be extracted by time period and implemented as a two-dimensional graph (x-axis: time, y-axis: feature value) (see FIG. 6).

At this time, the feature value extracted through the calculation formula using conversion values such as temperature, current, and voltage as input values is in the form of a wave, which fluctuates at first and then gradually converges to a constant value.

At this time, the diagnosis system 100 extract no feature values when the distance (wave height) between the ridge and furrow of the corresponding wave form is greater than r, but extract a median value (converged value) between the ridge and furrow as a feature value when the distance is smaller than r. Referring to FIG. 6, since t1 (time), the wave height has become smaller than r, and the diagnosis system 100 is able to extract the feature value of the car as K after t1. Here, since K is greater than the reference value a, it can be determined that the car's motor is in an abnormal state.

At this time, in extracting the feature value K, the diagnostic system 100 may extract a plurality of feature values by setting the time value for determining the median value between the crest and the trough to a designated time unit (or period).

In general, waves related to feature values fluctuate immediately after starting the engine, immediately after stepping on the brake, and immediately after stepping on the accelerator pedal, and the diagnosis system 100 extracts a feature value when the wave converges to a certain value after a certain time (for example, t1) and compares the feature value with the reference value to determine whether the motor is in an abnormal state or not.

According to an embodiment of the present invention, the size of r, which is a factor determining a feature value, may vary according to the current situation of the car (e.g., immediately after starting the engine, immediately after stepping on the brake, immediately after stepping on the accelerator pedal, etc.). As it is necessary to quickly determine whether or not there is an abnormality since immediately after stepping on the brake may be more dangerous than other times when driving a car

Accordingly, the diagnosis system 100 is able to set the size of r larger than other times at the time immediately after stepping on the brake, and may set the size of r as R as shown in FIG. 6 for convenience of explanation.

In such a state, immediately after stepping on the brake, the feature value fluctuated in the form of a wave, and the distance (wave height) between the ridge and the furrow became smaller than R after T1, and the diagnosis system 100 is able to extract a feature value for the motor of the car after T1, and compare it with a reference value a to determine an abnormal state.

As a result, as shown in FIG. 6, immediately after stepping on the brake, the feature value may be determined at the time point T1, which is earlier than t1, and accordingly, the abnormality can be quickly determined. Therefore, a driver can determine quickly if there is an abnormality and take quicker action.

In addition, depending on the case, the diagnosis system 100 is able to set the size of r to be smaller than other times at the time immediately after starting the engine. This is because the time immediately after starting the engine may be a time when there is more room than other times, so it is possible to accurately determine whether or not there is an abnormality. Therefore, after waiting until the fluctuation of the feature value disappears (later than the time t1), the diagnosis system 100 is able to extract the feature value for the motor of the car, and compares it with the reference value a to determine whether the state of motor is a normal state or an abnormal state.

That is, the diagnostic system 100 may extract, as feature values, singular points of the motor that occur after a specified point in time after the operation of a specific car function (e.g., starting, braking, accelerating pedal, etc.) is performed, and determine the state of the motor based on this.

In addition, the feature value to be extracted may represent the shape of a converging wave as described above, but may represent a feature based on an aperiodic state different from the shape of a wave according to various variables such as the state of the motor and the driving of the vehicle, and the diagnosis system 100 may extract these aperiodic features as feature values.

In addition, the diagnosis system 100 installed in a car (in the form of a PHM soc) of the present invention is able to diagnose the state of the installed motor in real time, and deliver the result to a driver through an infotainment for a car. That is, the diagnosis system 100 is able to prevent accidents by conveying information to the driver, such as whether there is an abnormality in the motor of the car and when the motor should be repaired.

In addition, the diagnosis system 100, when the state of the motor is determined as a failure state or a state in which failure is expected, is able to guide a nearby repair shop through the car infotainment, or automatically provide car information (for example, location, condition, etc.) to a nearby repair shop.

As described above, according to the present invention, the following effects are obtained.

According to various embodiments of the present invention, the present invention obtains an effect of diagnosing the state of a motor in a car through a diagnosis system located in the car, and determining not only whether the motor has failed but also a failure-expected period.

In addition, according to various embodiments of the present invention, the present invention obtains an effect of predicting the state of a motor more accurately through learning of an AI module by monitoring the state of a driving system in a car in real time using AI technology.

The above-described exemplary embodiments of the present invention may be implemented in the form of program commands that are executable through various computer components, and recorded on a computer-readable medium. The computer-readable medium may include program commands, data files, data structures, or the like solely or in combination. The program commands recorded on the computer-readable medium may be known and available to those skilled in the field of computer software. Examples of the computer-readable recording medium include a hardware device specially configured to store and execute program commands such as a hard disk, a read-only memory (ROM), a random access memory (RAM), a flash memory, etc. Examples of the program commands include not only machine language code generated by a compiler but also high-level language code that is executable by a computer using an interpreter or the like. The hardware device may be configured to operate as one or more software modules to perform operations according to the present invention, and vice versa.

Although the present invention has been described with specific details, such as specific components, limited embodiments and drawings, these are provided to facilitate general understanding of the present invention, and the present invention is not limited to the embodiments. Those skilled in the art can make various modifications and alterations from the description.

Therefore, the idea of the present invention should not be limited to the above-described embodiments, and it is to be noted that the spirit of the present invention encompasses not only the following claims but also all modifications equivalent to the claims.

What is claimed is:

1. A method for monitoring failure of a motor in a car based on a clustering algorithm when a system for monitoring failure of the motor is mounted in the car and includes a sensing module sensing the state of the motor, the method comprising:
(a) acquiring sensed values by sensing the state variables of the motor by the sensing module;
(b) extracting two or more feature values by converting the sensed values acquired by the sensing module;
(c) generating two or more clusters which classify and include the two or more feature values based on the two or more feature values and determining a normal cluster among the two or more clusters; and
(d) determining the state of the motor as a failure-expected state or a safe state by applying at least one classifier to the feature values included in the normal cluster.

2. The method according to claim 1,
wherein in the step (b) the two or more feature values are extracted based on a result of applying the sensed values to an equation having converted values of sensed temperatures, converted values of sensed voltages, and/or converted values of sensed currents as variables.

3. The method according to claim 1,
wherein in the step (c) the two or more clusters are generated based on a result of applying the feature values to a k-means clustering algorithm.

4. The method according to claim 1,
wherein in the step (d) the state of the motor is determined based on the classifier including at least some of a linear classification algorithm and/or a Gaussian classification algorithm.

5. The method according to claim 2,
wherein applying the sensed values to the equation is processed by at least one Artificial Intelligence (AI) module.

6. The method according to claim 3,
wherein applying the feature values to a clustering algorithm is processed by at least one AI module.

7. The method according to claim 4, wherein at least some of the classification algorithms are processed by at least one AI module.

8. The method according to claim 1,
wherein at least one feature value included in the normal cluster comprises information indicating a normal state or an abnormal state of the motor by comparison with at least one reference value preset.

9. The method according to claim 1,
wherein the step (c) comprises:
comparing the feature values located in domains designated as center points of each of the two clusters, or comparing mean values of the feature values when there are a plurality of the feature values located in the domains designated as the center points of each of the two clusters; and
determining, through the comparison, a cluster including a feature value relatively closer to a normal state based on the set reference value as a normal cluster.

10. The method according to claim 1,
Wherein the step (d) comprises:
determining, when the state of the motor is determined as the failure-expected state, a failure-expected period in which failure of the motor is expected based on the information indicating the failure-expected state of the motor, wherein the information is included in at least some of the feature values of the normal cluster.

11. A system for monitoring failure of a motor in a car based on a clustering algorithm, comprising:
a sensing module for sensing a state variables of the motor in the car and acquiring sensed values;
a motor state determination module for extracting two or more feature values by converting the sensed values acquired by the sensing module, and for generating two or more clusters that classify and include the two or more feature values based on the two or more feature values, and for determining a normal cluster among the two or more clusters, and for determining a state of the motor as a failure-expected state or a safe state by applying at least one classifier to the feature values included in the normal cluster,
wherein the system is mounted in the car.
